(19) United States
(12) Patent Application Publication
(10) Pub. No.: US 2013/0216791 A1
(43) Pub. Date: Aug. 22, 2013

(54) VACUUM INSULATED PANEL WITHOUT INTERNAL SUPPORT

(71) Applicants: Richard DeVos, Goshen, KY (US); Martin Christopher Severance, Louisville, KY (US); Jeffery Allen Tupis, Taylorsville, KY (US)

(72) Inventors: Richard DeVos, Goshen, KY (US); Martin Christopher Severance, Louisville, KY (US); Jeffery Allen Tupis, Taylorsville, KY (US)

(21) Appl. No.: 13/401,394

(22) Filed: Feb. 21, 2012

(51) Int. Cl. B32B 3/00; B32B 38/00

(52) U.S. Cl. 428/179; 156/197

(57) ABSTRACT

A thermal insulating structure comprises a first curved layer, the first curved layer having a first radius of curvature associated therewith, and a second curved layer, the second curved layer having a second radius of curvature associated therewith. The first radius of curvature is different than the second radius of curvature. The first curved layer and the second curved layer are sealed and a vacuum space is formed there between. The first curved layer and the second curved layer substantially maintain their respective shapes without internal support in the vacuum space there between.

### BACKGROUND OF THE INVENTION

The subject matter disclosed herein relates to vacuum insulated panels, and more particularly to improved vacuum insulated panels.

A vacuum insulated panel (or simply, a vacuum panel) is a structure that provides thermal insulation in a variety of applications. By way of example only, vacuum panels are used in appliances, such as refrigerators, to provide thermal insulation for the fresh food and freezer compartments. That is, one or more vacuum panels are installed in the doors and one or more vacuum panels are installed in each wall of the refrigerator to provide insulation against heat transfer inside the refrigerator.

A traditional vacuum panel is typically made up of two layers with a support material or structure internally installed between the layers to maintain the shape of the panel. An example of an internal support material is fiberglass. While air is removed from between the two layers forming a vacuum and thereby eliminating heat transfer via convection, the fiberglass between the two layers permits a heat transfer path via conduction between the two layers. This path thus reduces the panel's ability to insulate against heat transfer.

### BRIEF DESCRIPTION OF THE INVENTION

As described herein, the exemplary embodiments of the present invention overcome one or more disadvantages known in the art.

A first aspect of the present invention relates to a thermal insulating structure (e.g., a vacuum insulating panel or vacuum panel) that comprises a first curved layer, the first curved layer having a first radius of curvature associated therewith, and a second curved layer, the second curved layer having a second radius of curvature associated therewith. The first radius of curvature is different than the second radius of curvature. The first curved layer and the second curved layer are sealed and have a vacuum space formed there between. The first curved layer and the second curved layer substantially maintain their respective shapes without internal support in the vacuum space there between.

In one embodiment, the thermal insulating structure further comprises at least one support member. The support member is in contact with at least one of the first curved layer and the second curved layer and external to the vacuum space formed there between. The support member assists in substantially maintaining the respective shapes of the first curved layer and the second curved layer.

In another embodiment, the first curved layer and the second curved layer each have a respective thickness associated therewith such that the first curved layer and the second curved layer substantially maintain their respective shapes when sealed together and subjected to an outside force used to form the vacuum space there between.

In a further embodiment, the first curved layer and the second curved layer each have a respective thickness associated therewith such that the first curved layer and the second curved layer substantially maintain their respective shapes when sealed together and subjected to a thermal bimetallic effect used to form the vacuum space there between.

A second aspect of the present invention relates to a system that comprises a compartment requiring thermal insulation and a thermal insulating structure positioned in proximity of the compartment. The thermal insulating structure comprises a first curved layer, the first curved layer having a first radius of curvature associated therewith, and a second curved layer, the second curved layer having a second radius of curvature associated therewith. The first curved layer and the second curved layer are sealed and have a vacuum space formed there between. One of the first curved layer and the second curved layer is in compression and the other of the first curved layer and the second curved layer is in tension. The first curved layer and the second curved layer substantially maintain their respective shapes without internal support in the vacuum space there between.

A third aspect of the present invention relates to a method that comprises the steps of: placing a first curved layer in contact with a second curved layer, the first curved layer having a first radius of curvature associated therewith and the second curved layer having a second radius of curvature associated therewith, the first radius of curvature being different than the second radius of curvature; sealing corresponding edges of the first curved layer and the second curved layer; and changing the first radius of curvature and the second radius of curvature causing separation between the first curved layer and the second curved layer thus forming a vacuum space there between while the first curved layer and the second curved layer substantially maintain their respective shapes without internal support in the vacuum space there between.

Advantageously, illustrative embodiments of the present invention provide a thermal insulating structure wherein conductive and convective heat transfer through the interior of the thermal insulating structure is reduced or eliminated. Such improved thermal insulating structures may be deployed in a variety of systems including, but not limited to, appliances.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a diagram of a top view of a thermal insulating structure, according to an embodiment of the invention.

FIG. 2 is a diagram of a rear view of a thermal insulating structure, according to an embodiment of the invention.

FIG. 3 is a diagram of a front view of a thermal insulating structure, according to an embodiment of the invention.

FIG. 4 is a diagram of a top view of a thermal insulating structure, according to another embodiment of the invention.

FIG. 5 is a diagram of a top view of a thermal insulating structure, according to a further embodiment of the invention.

FIGS. 6 and 7 are diagrams of a methodology for forming a thermal insulating structure, according to yet another embodiment of the invention.

FIG. 8 is a diagram of a refrigerator with one or more thermal insulating structures installed, according to an embodiment of the invention.

FIG. 9 is a diagram of a water heater with one or more thermal insulating structures installed, according to another embodiment of the invention.

FIG. 10 is a diagram of a top view of a water heater with a thermal insulating structure installed, according to yet another embodiment of the invention.

### DETAILED DESCRIPTION OF THE EXEMPLARY EMBODIMENTS OF THE INVENTION

One or more illustrative embodiments of the invention will be described below in the context of an appliance. However, it is to be understood that embodiments of the invention are not intended to be limited to use with appliances. Rather, embodiments of the invention may be applied to and deployed in any other suitable environment or system in which it would be desirable to provide improved vacuum panels for thermal insulation.

As illustratively used herein, the term “appliance” is intended to refer to any device or equipment designed to perform one or more specific functions. This may include, but is not limited to, equipment for consumer use, e.g., a refrigerator, a dishwasher, an oven, a water heater, etc. This may also include, but is not limited to, any equipment that is useable in household or commercial environments.

Traditional vacuum panels are known to be thick and poor insulators. It is realized that the ideal vacuum panel eliminates heat transfer through conduction and convection, thus leaving the third mode of heat transfer, radiation, as the only method of transferring heat. Traditional vacuum panels do not come close to achieving this ideal heat transfer state due to the need for internal structural separation of the outer layer of the vacuum panel from the inner layer of the vacuum panel. An example of this internal structural separation or support component is fiberglass. This internal structure or material necessarily conducts heat, thus degrading the performance of the vacuum panel.

Illustrative embodiments of the invention reduce the valuable space requirement for the vacuum panel by reducing the thickness, and improve the insulating properties by reducing or eliminating the conduction through the panel.

The physics of radiation heat transfer between two parallel plates (layers) separated by a vacuum determines that the rate of heat transfer is not dependent on the distance between the plates. Thus, it is realized herein that the ideal panel would be two thin plates that are separated by a vacuum gap that is greater than zero units of separation distance. As will be described in detail herein, illustrative embodiments of the invention provide vacuum panel designs and methods to manufacture a vacuum panel with increased thermal resistance and reduced thickness, as compared with existing vacuum panels.

More particularly, illustrative embodiments of the invention provide a vacuum panel that derives its physical support from outside of the panel rather than from inside as with traditional vacuum panels. This is advantageous since this method eliminates conduction through the inside of the vacuum panel that is normally associated with the physical support that is typical of traditional vacuum panels. Current technology uses low internal pressure together with external force provided by the atmosphere to compress an impermeable film against a low conductivity material to provide a relatively rigid structure. Typically, the film will surround the low conductivity material.

In contrast, as will be explained further herein, illustrative embodiments of the invention provide methods to reduce the amount of conducted heat by removing the support material from the center of the vacuum panel. In one or more illustrative embodiments, the resultant loss in structure is offset by the addition of support structure on the exterior of the vacuum panel. In one or more other embodiments, the loss in structure is offset by the selected thickness and manufacturing process of the panel.

It is realized that the external forces on a vacuum panel are relatively large, given that atmospheric pressure is 14 pounds per square inch. Thus, one may suggest using thick rigid flat plates when forming the vacuum panel. While such a design would accomplish the elimination of conduction, it has the disadvantage of requiring extra thickness to withstand the cantilever stress that the atmospheric pressure provides. This increase in thickness results in high thermal conduction at the edges of the plates and results in excessive material usage in terms of thickness.

Illustrative embodiments of the invention provide for reducing the material thickness by changing the shape of the materials to balance structural stress along the length and width of the panel face against one or more support members. In practice, this may dictate a continuous cylindrical or spherical vacuum panel. This may not always be practical in application and, therefore, an external structural member is added to allow the use of truncated curved surfaces to be used to support the forces associated with the pressure that would cause the exterior forces to collapse the panel.

In accordance with one or more illustrative embodiments of the invention, the outside layer of the vacuum panel is formed in a curved shape, as is the inside layer. However, in at least one embodiment, the radius of curvature associated with the outside layer is slightly smaller than the radius of curvature of the inside surface. The outside layer, with pressure being applied to the outside of the layer, is therefore under compression and tends to a natural state that is flatter than the designed curvature. This compressive stress needs to be counterbalanced. Illustrative embodiments provide one or more external support members to offset the compressive forces and maintain the vacuum panel shape. The one or more support members are sufficient to offset the buckling stresses in the outside layer and sufficient to offset the forces applied by the inner layer. The forces applied by the inside layer are generated when the vacuum pulls on the area of the panel in the direction of the outside layer. This force causes the panel to tend to a smaller radius, pulling the ends of the panel inward toward each other. The one or more external structural members are applied to the vacuum panel assembly to offset this force, maintaining the distance between the ends of the panel.

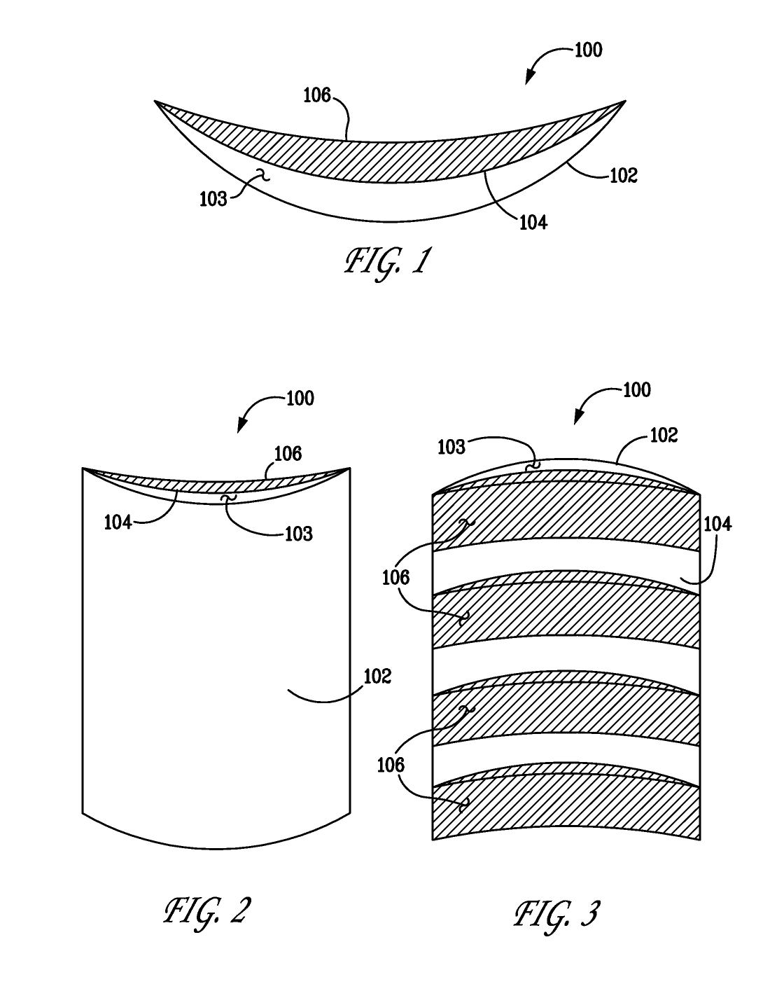

It is to be understood that while reference in the figures below will be made to illustrative top, front, rear, and side views of a vacuum panel, these spatial orientations are relative to the specific design of the panel given the system in which it will be installed. In other words, by way of example only, the panel may be so installed such that the “top view” shown in FIG. 1 may in fact be the side of the panel, and so forth, with regard to the other views. Thus, the views shown are for purposes of illustrative explanation and for an understanding of the positioning of the components of a vacuum panel with regard to one another.

FIGS. 1-3 are diagrams of top, rear and front views, respectively, of a thermal insulating structure, e.g., vacuum panel, according to an embodiment of the invention.

As shown in the figures, thermal insulating structure 100 comprises a first curved layer 102, a second curved layer 104, a vacuum space 103 between the two layers 102 and 104, and one or more support members 106 (in this embodiment, the one or more support members are in contact with curved layer 104). Note that the top of the structure 100 is shown as a cutaway view so that the layers, and inner space between the layers, can be more readily seen. However, as will be explained below, all edges of the two layers are sealed when the structure is formed so as to maintain a vacuum.

It is to be understood that the term “vacuum,” as used in conjunction with illustrative embodiments of the invention, represents the absence of material and, further, the area of vacuum is actually an area of reduced pressure that provides reduced convective and conductive heat transfer.

Each curved panel has a radius of curvature associated therewith. It is to be appreciated that while the two layers that make up the thermal insulating structure 100 are curved in a partial circular or spherical form, embodiments of the invention are not so limited. That is, the layers may take on other curved forms (by way of example only, see the thermal insulating structure in FIG. 5 which will be described in detail later). Thus, it is to be understood that when the form of the layer is a partial circle or sphere, the radius of curvature is the distance from the theoretical center of the circle or sphere to its surface. For other curved lines or surfaces, the radius of curvature at a given point is the radius of a circle that theoretically best fits the curve at that point. One of ordinary skill in the art will appreciate how the radius of curvature of each layer may be calculated.

As can be seen in the thermal insulating structure 100 of FIGS. 1-3, the radius of curvature of curved layer 102 is different than the radius of curvature of curved layer 104. It is realized that if a layer is allowed to collapse when fabricating the structure without external support, the distance between the layers becomes reduced and the layers may even touch. This would result in a thermal short circuit thus allowing thermal energy to pass between the two layers. This is one main reason why embodiments of invention start with curved panels situated next to one another and, when forming the structure, the distance between the layers is expanded. This expansion changes the radius of each layer, and thus the distance between the inside surfaces of the layers increases.

Advantageously, since there is no gas between the layers, but the volume of the space 103 between the layers 102 and 104 increases, the result is the formation of a vacuum between the layers. This process assumes that air will not enter from the edges of the layers. Therefore, the edges of the layers are sealed prior to separation of the layers. For example, this sealing process may be any conventional method of providing a hermetic seal between two materials. As mentioned above, while the top of the structure 100 is shown opened in the figures, this is merely a cutaway view for illustration purposes only and, as such, it is to be understood that the corresponding edges at the top, bottom and sides of the two layers 102 and 104 are sealed to form the vacuum space 103 there between.

The front view in FIG. 3 illustrates a plurality of support members 106, however, it is to be appreciated that a single support member and/or one or more support members with other shapes can be used depending on the geometry of the thermal insulating structure, which is dictated by the system in which the structure is to be installed. Thus, while FIG. 3 shows multiple support members 106 in a rib-like arrangement formed on the exterior surface of layer 104, many alternative arrangements will be realized by those of ordinary skill in the art given the illustrative descriptions herein.

Support members 106 are sized and spaced, sufficient to resist the deformation caused by the pressure that is external to the evacuated panel. The support should be sufficiently strong to prevent contact between the layers 102 and 104.

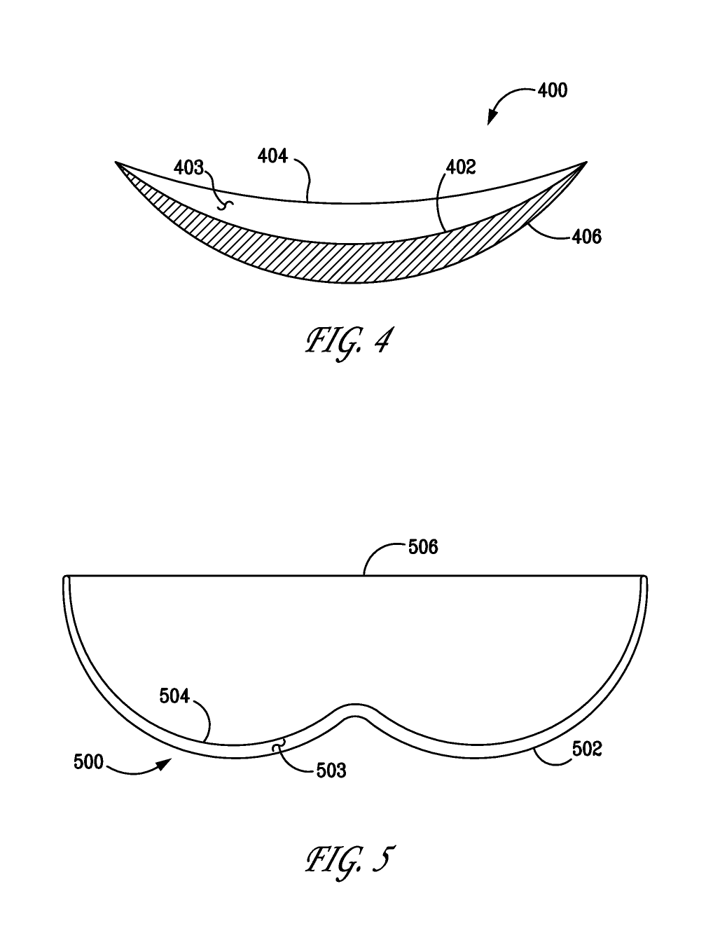

Referring now to FIG. 4, a top view is shown of a thermal insulating structure, according to an alternative embodiment of the invention. In comparison to the top view in FIG. 1 with regard to thermal insulating structure 100, the top view of thermal insulating structure 400 in FIG. 4 shows the one or more support members mounted on the outside surface of the opposite layer.

Thus, assuming layer 402 corresponds to layer 102, layer 404 corresponds to layer 104, and vacuum space 403 corresponds to vacuum space 103, the one or more support members 406 in FIG. 4 are mounted on the outside surface of layer 402. As such, the support members would be located on the rear side of the structure 400.

Note that when we refer to the front and rear of the structure above, it is in relation to the mounting orientation of the structure in the system in which it will be installed, and thus other orientations are possible (e.g., top and bottom, side to side, etc.). In a refrigerator door installation (as will be explained below in the context of FIG. 8), the “front” of the structure (layer 104 in FIG. 1 and layer 404 in FIG. 4) is the side of the structure that is facing in toward the refrigerator compartment (fresh food or freezer) and the “rear” of the structure (layer 102 in FIG. 1 and layer 402 in FIG. 4) is the side of the structure facing out from the refrigerator compartment. The direction of curvature is oriented to provide the maximum space to the interior of the refrigerator. Again, recall that the terms “front,” “rear,” “top,” “bottom” and side are relative terms.

FIG. 5 is a diagram of a top view of a thermal insulating structure, according to another alternative embodiment of the invention. Thermal insulating structure 500 illustrates one example of a layer shape that is not necessarily in a singular circular or spherical form. In this embodiment, the two layers 502 and 504 (corresponding to layers 102 and 104) are in bow shapes with a vacuum space 503 formed there between. Note that layer 502 has a different radius of curvature than layer 504. The support member(s) 506 are shown mounted to layer 504. In this embodiment, support member(s) 506 are in the form of one or more compressive beams that maintain the curvature of layer 504.

Layer 504 will have compressive stress through the thickness in the convex areas of the layer. The compressive stress is established when the atmospheric pressure is applied to the exterior of the convex vacuum panel applying force to the center of the local radius. The thermal insulating structure thickness is designed to be sufficient to prevent contact between 502 and 504 by resisting compressive buckling deformation when the panel is evacuated. The support member(s) 506 is designed to be sufficient to prevent contact between 502 and 504 by resisting compressive buckling deformation when the panel is evacuated.

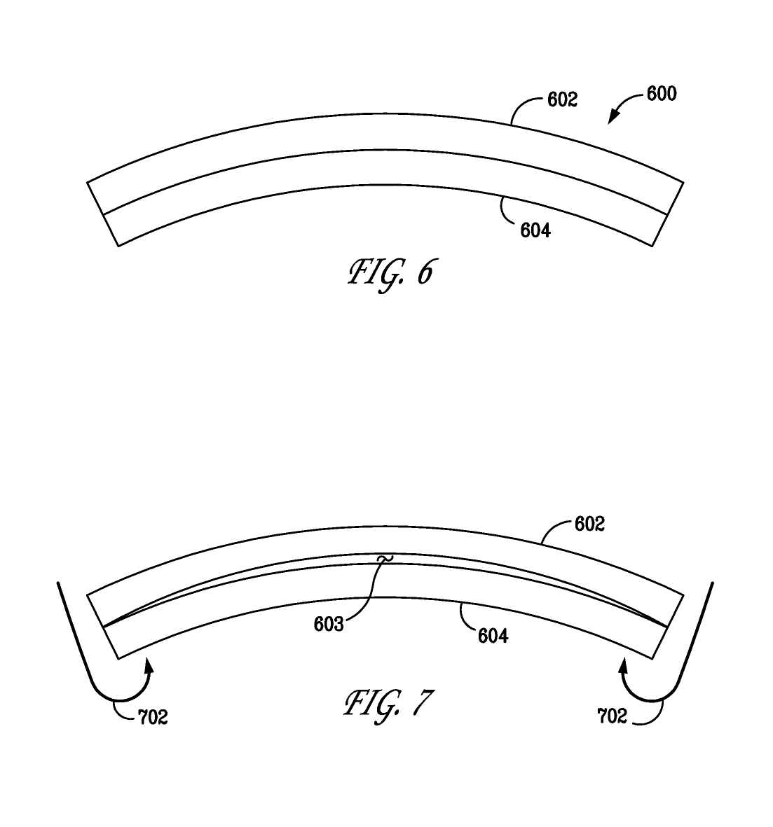

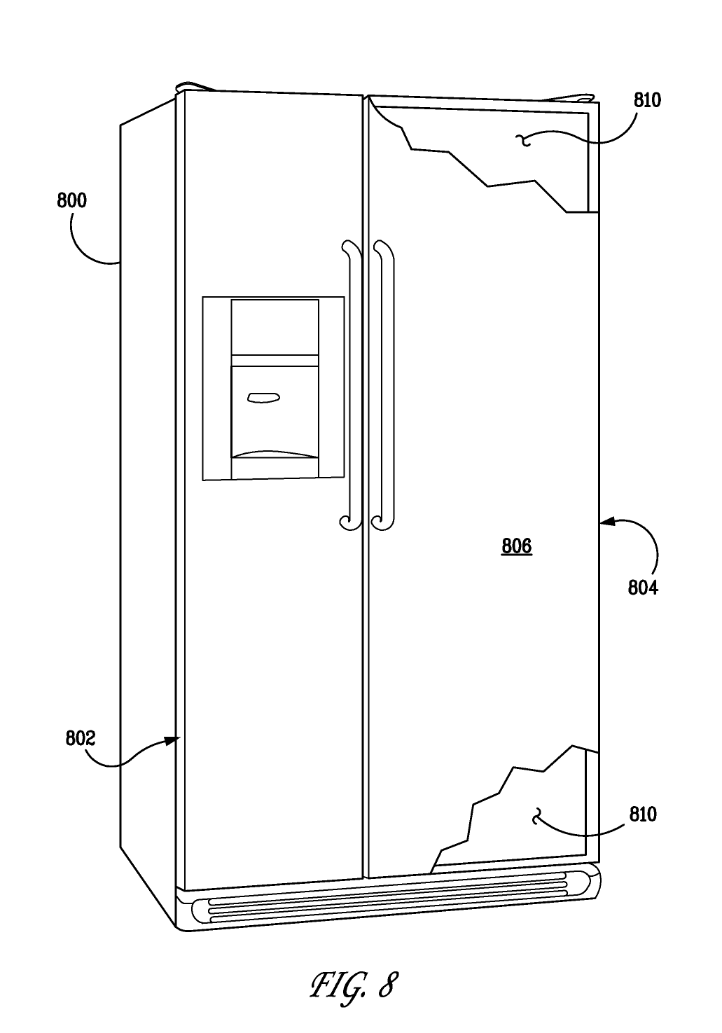

FIGS. 6 and 7 are diagrams of a methodology for forming a thermal insulating structure 600, according to yet another embodiment of the invention. In the figures, assume that layer 602 corresponds to layer 102 (of FIG. 1), layer 604 corresponds to layer 104, and vacuum space 603 corresponds to vacuum space 103.

In the embodiment shown in FIGS. 6 and 7, it is realized that if the materials that form the layers 602 and 604 are thick enough to prevent buckling or collapse of the layers against one another, a further method of forming the structure 600 is as follows.

As illustrated in FIG. 6, layers 602 and 604 are first placed together in contact with one another. The edges are sealed, as explained above. Then, as shown in FIG. 7, the layers are separated by a force 702 provided by a force-applying member (not shown) on the edges of the layers that provides a bending moment on each edge. A spring clip is one example of a force-applying member. The layers separate forming a vacuum space 603 there between.

It is to be appreciated that the thickness of each layer 602 and 604 is selected to be large enough to prevent compressive buckling in the layers and is dependent on the specific geometry of the layers. By way of example only, the thickness of each layer may be derived through conventional finite element analysis (FEA) techniques based on a selection of specific geometries of the layers given a specific application in which the structure is to be deployed. That is, one of ordinary skill in the art will be able to determine appropriate layer thicknesses via FEA techniques based on the given geometry and the given application.

As such, thermal insulating structure embodiments of the invention that utilize layers of such non-buckling/collapsing thickness can be formed without one or more support members assisting in substantially maintaining the respective shapes of the two layers. However, it is to be appreciated that one or more such support members, as illustratively described herein, can be utilized in the structure depicted in FIGS. 6 and 7 to add additional support to the structure. Also, it is to be appreciated that one or more of the embodiments shown in FIGS. 1-5 can be formed using one or more of the methodologies described in the context of FIGS. 6 and 7.

Thus, while one method of forming thermal insulating structure 600 is to put the first and second curved layers in contact with each other, seal them, and then separate them by mechanically increasing the curvature of the assembly, and thus increasing the curvature of each layer of the assembly (thereby changing their respective radii of curvature), causing separation between the layers, alternative methods may be employed to form the structure.

For example, an alternative method of manufacturing the structure comprises the first and second curved layers being placed in contact with each other, then sealed, and then separated by increasing the curvature of the assembly through a thermal bimetallic effect causing separation between the layers.

More particularly, the process involves placement of the two layers in contact with each other, allowing minimal space for trapped air, then sealing the layers together at the edges. These steps are performed at a temperature different from the operating temperature in the application (i.e., the application in which the structure will be deployed). As the layers move to ambient temperature, the inside layer shrinks faster than the outside layer, causing it to pull away from the outside layer. For example, this can occur in one of two ways. First, if the inside layer has a higher thermal coefficient of expansion than the outside layer, then the sealing operation that ties the layers together should be performed at a higher temperature than ambient temperature. Second, if the inside layer has a lower thermal coefficient of expansion than the outside layer, then the sealing operation that ties the layers together should be performed at a lower temperature than ambient temperature. Example materials with different coefficients of expansion include, but are not limited to, copper/steel, silicone/aluminum, and TiWN/TiN.

FIG. 8 is a diagram of an appliance with one or more thermal insulating structures installed, according to an embodiment of the invention. More particularly, FIG. 8 shows a refrigerator appliance 800 with a side-by-side configuration. That is, the refrigerator 800 has a freezer compartment 802 next to a fresh food compartment 804.

A thermal insulating structure 810, formed in accordance with one or more embodiments described herein, is shown (in a cutaway view) installed in the door 806 of the fresh food compartment. Other similar thermal insulating structures (not expressly shown) could be installed in other doors, sides, top and bottom of the refrigerator 800. The thermal insulating structure 810 acts as a vacuum panel that thermally insulates the compartments of the refrigerator, thus reducing or eliminating the transfer of thermal energy from outside the refrigerator to inside the refrigerator compartments.

Note that while the thermal insulating structure 810 is shown as being mounted behind the material that makes up the surface (skin) of door 806, it is to be understood that the outer surface of the thermal insulating structure could serve as the outer surface of the refrigerator door itself. That is, the structure may be exposed to the consumer and painted.

The application of a thermal insulating structure to a refrigerator may have the following exemplary attributes. Materials used to form the two layers of the structure are relatively thin and dependent of the type of material. Steel thickness is designed to avoid buckling and dependent of the distance between the supports. Preferred material thickness is less than about 0.060 inches of steel for the application without support members. The thickness would be greater if the layers are formed from aluminum. A preferred radius for the refrigerator door matches a typical commercially-available door, e.g., between about 30 and about 100 inches. The structure could be used in the sides of the refrigerator, as mentioned above, either applied to the exterior with a radius larger than about 300 inches or to the interior where radiuses may be smaller.

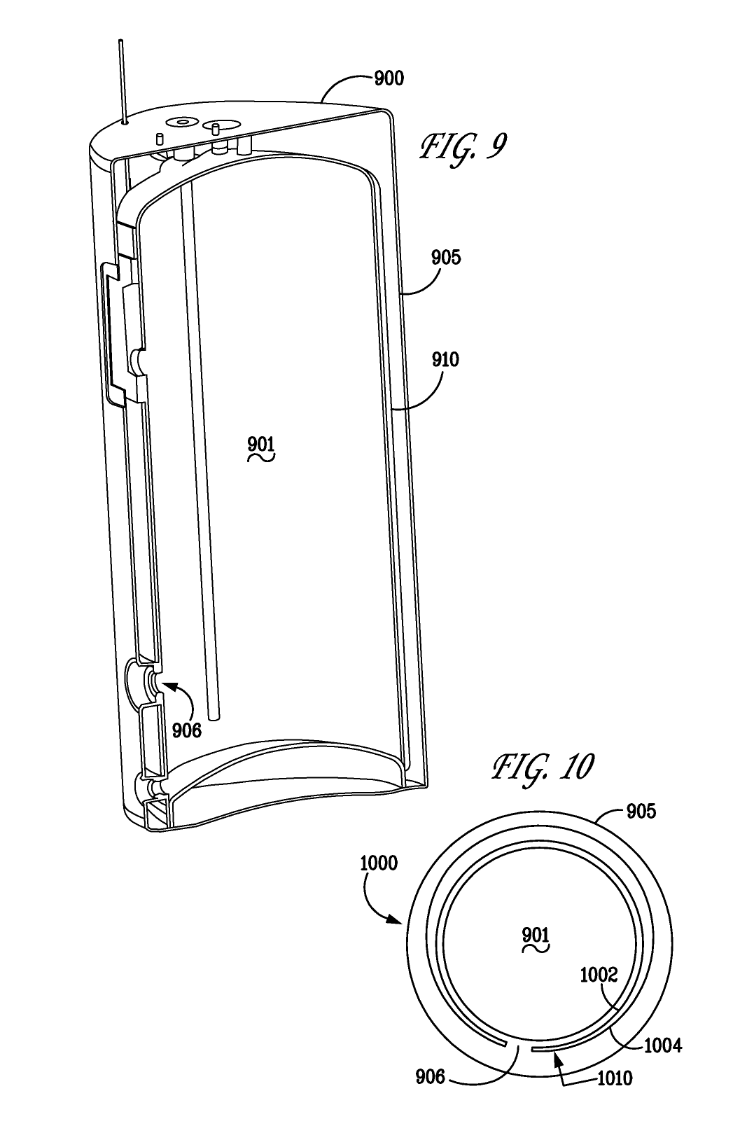

FIG. 9 is a diagram of an appliance with one or more thermal insulating structures installed, according to another embodiment of the invention. More particularly, FIG. 9 shows a cross sectional view of a water heater appliance 900.

A thermal insulating structure 910, formed in accordance with one or more embodiments described herein, is shown installed around a water heater tank 901. The external appearance cover 905 surrounds the tank 901 and the thermal insulating structure 910. Access port 906 is formed through the external appearance cover, the thermal insulating structure and the tank.

It can be seen that since FIG. 9 is a cross sectional view, another similar thermal insulating structure would be installed around the other side of the heater (not shown due to cross sectional view). The one or more thermal insulating structures act as vacuum panels that thermally insulate the tank compartment 901 of the water heater, thus reducing or eliminating the transfer of thermal energy from inside the water heater to outside the water heater.

Note that while the thermal insulating structure 910 is shown as being installed beneath the outer layer (external appearance cover) of the water heater, the thermal insulating structure, itself, could serve as the outer cover of the water heater in an alternative embodiment.

FIG. 10 is a diagram of a top view of a water heater 1000 with a thermal insulating structure installed, according to yet another embodiment of the invention. The water heater embodiment in FIG. 10 is similar to the water heater embodiment in FIG. 9, with the exception that thermal insulating structure 1010 in FIG. 10 is a substantially continuous circular panel with an inner layer 1002 and an outer layer 1004. The layers are joined together on each side of access port 906. However, the thermal insulating structure operates in the same or a similar advantageous manner as other thermal insulating structures described herein.

Advantageously, the thermal insulating structure may be thinner than conventional water heater insulation (e.g., foam or fiberglass). Also, as with other embodiments, the thermal insulating structure may have external mechanical support on either curved layer to prevent collapse or buckling of the structure.

Thus, while there have been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A thermal insulating structure comprising:
a first curved layer, the first curved layer having a first radius of curvature associated therewith; and
a second curved layer, the second curved layer having a second radius of curvature associated therewith, the first radius of curvature being different than the second radius of curvature, wherein the first curved layer and the second curved layer are sealed and have a vacuum space formed there between, and the first curved layer and the second curved layer substantially maintain their respective shapes without internal support in the vacuum space there between.

2. The thermal insulating structure of claim 1, wherein the first curved layer and the second curved layer each have a respective thickness associated therewith such that the first curved layer and the second curved layer substantially maintain their respective shapes when sealed together and subjected to an outside force used to form the vacuum space there between.

3. The thermal insulating structure of claim 1, wherein the first curved layer and the second curved layer each have a respective thickness associated therewith such that the first curved layer and the second curved layer substantially maintain their respective shapes when sealed together and subjected to a thermal bimetallic effect used to form the vacuum space there between.

4. The thermal insulating structure of claim 1, further comprising at least one support member, the at least one support member being in contact with at least one of the first curved layer and the second curved layer and external to the vacuum space formed there between, and the at least one support member assisting in substantially maintaining the respective shapes of the first curved layer and the second curved layer.

5. The thermal insulating structure of claim 4, wherein the at least one support member is attached to the structure, external to the vacuum space, to offset a buckling stress in one of the first curved layer and the second curved layer and to offset a force applied by the other of the first curved layer and the second curved layer.

6. The thermal insulating structure in claim 4, wherein the at least one support member prevents contact between the first curved layer and the second curved layer by resisting compressive buckling deformation when the space there between is evacuated.

7. The thermal insulating structure of claim 1, wherein the first curved layer and the second curved layer each comprises edges, and corresponding edges of the first curved layer and the second curved layer are hermetically sealed.

8. The thermal insulating structure in claim 1, wherein one of the first curved layer and the second curved layer comprises one or more areas that are in compression throughout the given thickness of the one of the first curved layer and the second curved layer.

9. The thermal insulating structure in claim 8, wherein the given thickness of the one of the first curved layer and the second curved layer prevents contact between the first curved layer and the second curved layer by resisting compressive buckling deformation when the space there between is evacuated.

10. A system comprising:
a compartment requiring thermal insulation; and
a thermal insulating structure positioned in proximity of the compartment, the thermal insulating structure comprising: a first curved layer, the first curved layer having a first radius of curvature associated therewith; and a second curved layer, the second curved layer having a second radius of curvature associated therewith, wherein the first curved layer and the second curved layer are sealed and have a vacuum space formed there between, wherein one of the first curved layer and the second curved layer is in compression and the other of the first curved layer and the second curved layer is in tension, and the first curved layer and the second curved layer substantially maintain their respective shapes without internal support in the vacuum space there between.

11. The system of claim 10, wherein the first curved layer and the second curved layer of the thermal insulating structure each have a respective thickness associated therewith such that the first curved layer and the second curved layer substantially maintain their respective shapes when sealed together and subjected to an outside force used to form the vacuum space there between.

12. The system of claim 10, wherein the first curved layer and the second curved layer of the thermal insulating structure each have a respective thickness associated therewith such that the first curved layer and the second curved layer substantially maintain their respective shapes when sealed together and subjected to a thermal bimetallic effect used to form the vacuum space there between.

13. The system of claim 10, wherein the thermal insulating structure further comprises at least one support member, the at least one support member being in contact with at least one of the first curved layer and the second curved layer and external to the vacuum space formed there between, and the at least one support member assisting in substantially maintaining the respective shapes of the first curved layer and the second curved layer.

14. The system of claim 13, wherein the at least one support member of the thermal insulating structure is attached to the structure, external to the vacuum space, to offset a buckling stress in one of the first curved layer and the second curved layer and to offset a force applied by the other of the first curved layer and the second curved layer.

15. The system of claim 10, wherein the first curved layer and the second curved layer of the thermal insulating structure each comprises edges, and corresponding edges of the first curved layer and the second curved layer are hermetically sealed.

16. The system of claim 10, wherein the compartment requiring thermal insulation is an appliance compartment.

17. The system of claim 16, wherein the appliance compartment is part of one of a refrigerator and a water heater.

18. A method of forming a thermal insulating structure, comprising:
placing a first curved layer in contact with a second curved layer, the first curved layer having a first radius of curvature associated therewith and the second curved layer having a second radius of curvature associated therewith, the first radius of curvature being different than the second radius of curvature,
sealing corresponding edges of the first curved layer and the second curved layer; and
changing the first radius of curvature and the second radius of curvature causing separation between the first curved layer and the second curved layer thus forming a vacuum space there between while the first curved layer and the second curved layer substantially maintain their respective shapes without internal support in the vacuum space there between.

19. The method of claim 18, wherein the step of changing the first radius of curvature and the second radius of curvature causing separation between the first curved layer and the second curved layer is performed by applying a mechanical force.

20. The method of claim 18, wherein the step of changing the first radius of curvature and the second radius of curvature causing separation between the first curved layer and the second curved layer is performed via a thermal bimetallic effect.
